(19) United States
(12) Patent Application Publication
(10) Pub. No.: US 2016/0075228 A1
(43) Pub. Date: Mar. 17, 2016

(54) Fuel tank

(71) Applicant: Yu-Peng Chan, Changhua (TW)

(72) Inventor: Yu-Peng Chan, Changhua (TW)

(21) Appl. No.: 14/953,408

(22) Filed: Nov. 29, 2015

(51) Int. Cl. B60K 15/03

(52) U.S. Cl. CPC B60K 15/03

(57) ABSTRACT

An automotive fuel tank is described and includes an upper covering including a flexible, protruding bottom edge; and a lower covering including a flexible, protruding top edge secured to the bottom edge. The automotive fuel tank is structurally strong and can withstand collision without causing cracks after a long period of time of use.

### BACKGROUND OF THE INVENTION

1. Field of the Invention

The invention relates to fuel tanks and more particularly to an automotive fuel tank having increased structural strength.

2. Description of Related Art

A conventional automotive fuel tank is shown in FIGS. 1, 1A and 2 and comprises a covering A and two end members B secured to two ends of the covering A by welding respectively. However, cracks can be caused on the covering A after a period of time of use due to low structural strength thereof.

Thus, the need for improvement still exists.

### SUMMARY OF THE INVENTION

It is therefore one object of the invention to provide an automotive fuel tank comprising an upper covering including a flexible, protruding bottom edge; and a lower covering including a flexible, protruding top edge secured to the bottom edge.

The above and other objects, features and advantages of the invention will become apparent from the following detailed description taken with the accompanying drawings.

### BRIEF DESCRIPTION OF THE DRAWINGS

FIG. 1 is an exploded view of a conventional automotive fuel tank;

FIG. 1A is a perspective view of the assembled fuel tank shown in FIG. 1;

FIG. 2 is a longitudinal sectional view of the fuel tank shown in FIG. 2;

FIG. 3 is a longitudinal sectional view showing an upper covering being produced in upper and lower dies;

FIG. 3A is an exploded view showing a produced upper covering;

FIG. 4 is an exploded view of an automotive fuel tank according to the invention;

FIG. 4A is a perspective view of the assembled automotive fuel tank shown in FIG. 4;

FIG. 5 is a longitudinal sectional view of the automotive fuel tank shown in FIG. 4A;

FIG. 6 is a view similar to FIG. 5 showing the bottom edges and the top edges being bent; and

FIG. 7 is a view similar to FIG. 6 showing the fuel tank mounted in an automobile.

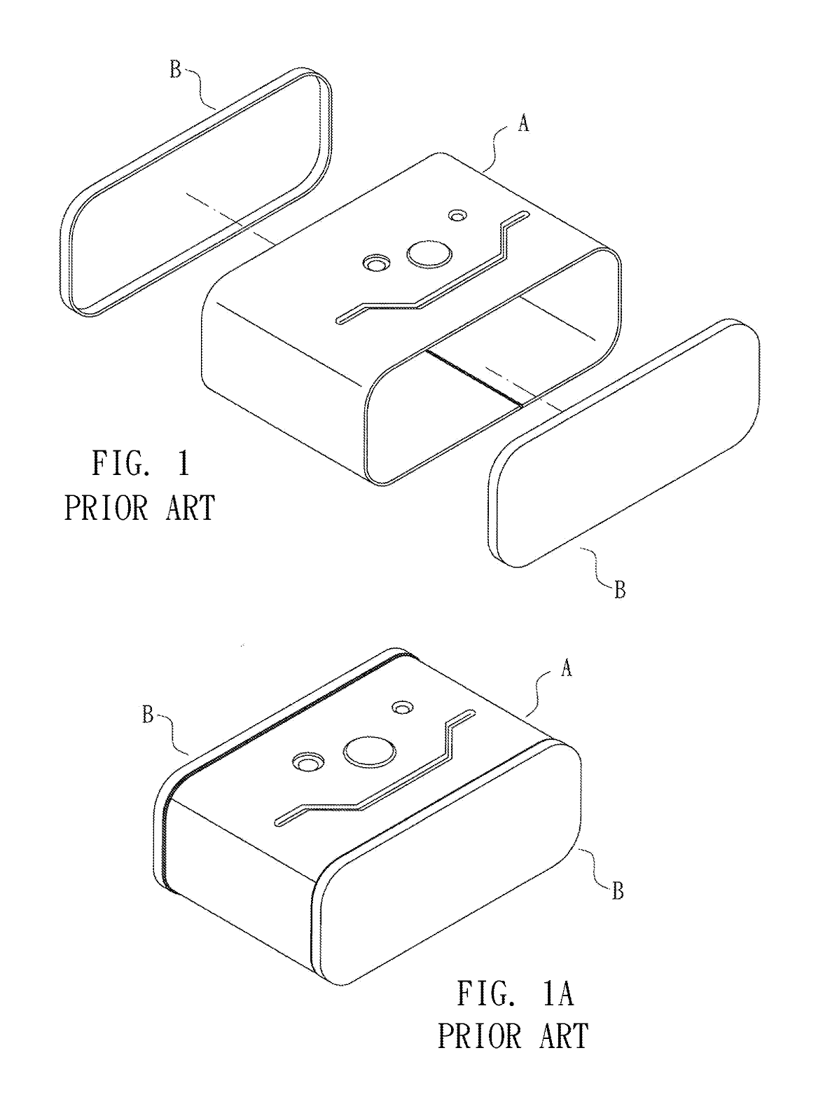

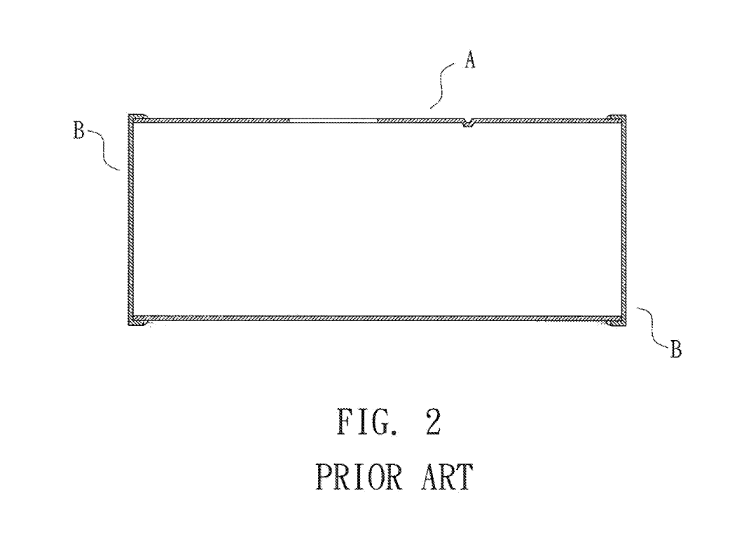

### DETAILED DESCRIPTION OF THE INVENTION

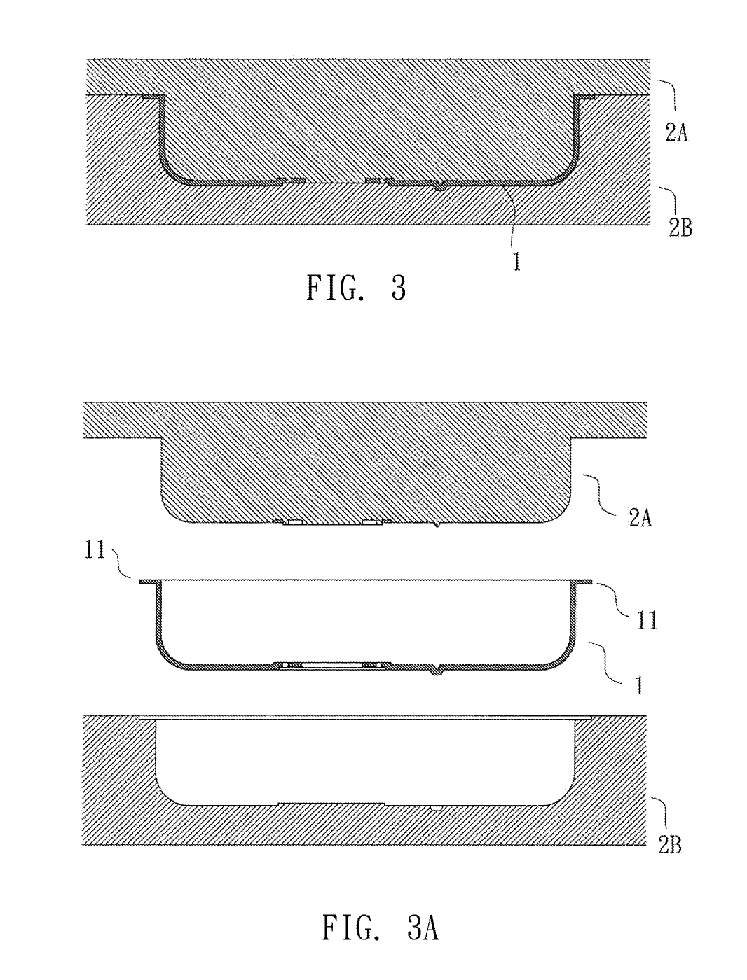

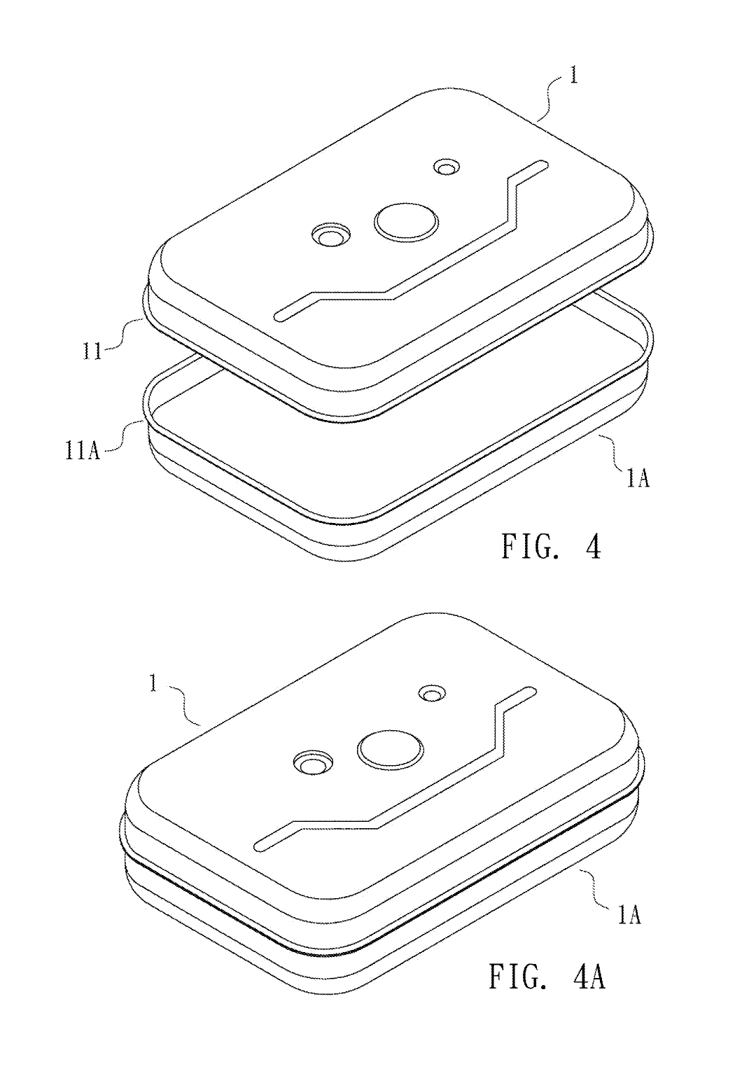

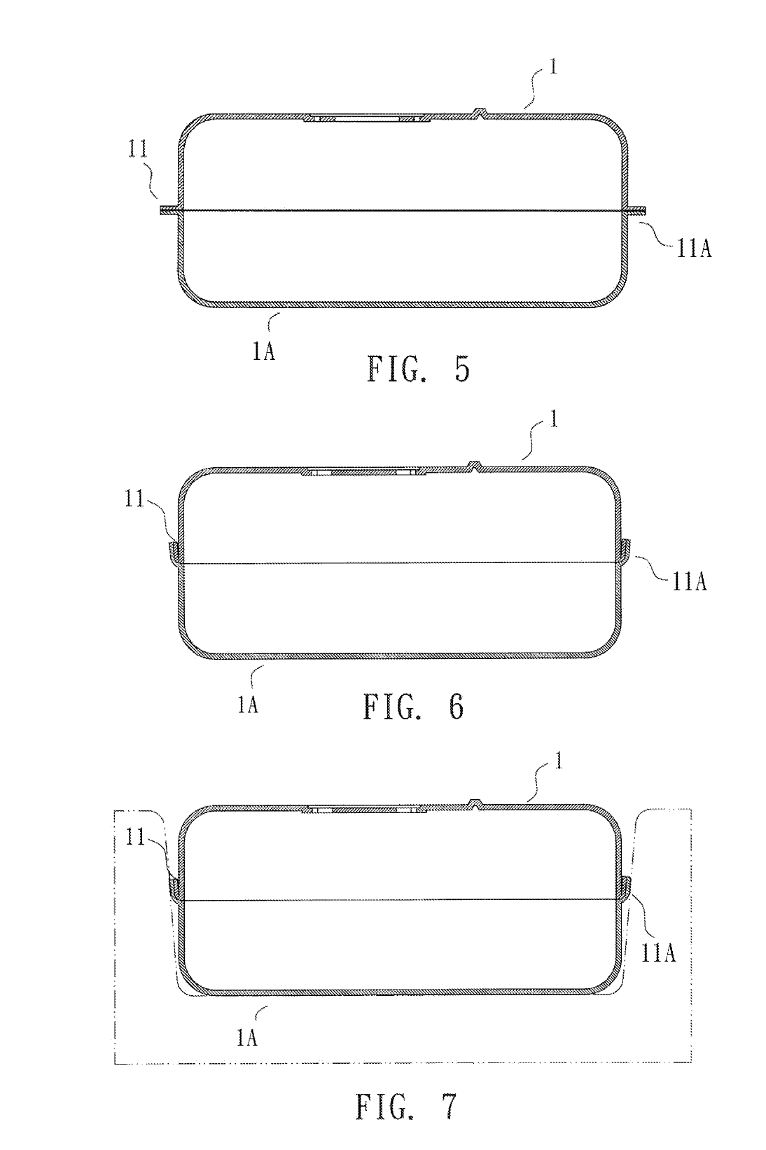

Referring to FIGS. 3 to 7, an automotive fuel tank in accordance with the invention comprises an upper covering 1 including a flexible, protruding bottom edge 11; and a lower covering 1A including a flexible, protruding top edge 11A. The bottom edge 11 and the top edge 11A are secured together. The assembled fuel tank can be mounted in an automobile by bending the bottom edge 11 and the top edge 11A.

As shown in FIGS. 3 and 3A specifically, the upper covering 1 is produced in steps comprising injecting molten metal or plastic into a cavity between an upper die 2A and a lower die 2B, cooling the dies 2A, 2B, separating the dies 2A, 2B, and taking out the produced upper covering 1. Likewise, the lower covering 1A can be produced in the same manufacturing process.

It is envisaged by the invention that the automotive fuel tank is structurally strong and can withstand collision without causing cracks.

While the invention has been described in terms of preferred embodiments, those skilled in the art will recognize that the invention can be practiced with modifications within the spirit and scope of the appended claims.

What is claimed is:

1. An automotive fuel tank comprising:
an upper covering including a flexible, protruding bottom edge; and
a lower covering including a flexible, protruding top edge secured to the bottom edge.
